(19) United States
(12) Patent Application Publication
(10) Pub. No.: US 2004/0127630 A1
(43) Pub. Date: Jul. 1, 2004

(54) Flame resistant polypropylene compounds

(76) Inventor: Rene Herbiet, Eupen (BE)

Correspondence Address: MANELLI DENISON & SELTER, 2000 M STREET NW SUITE 700, WASHINGTON, DC, 20036-3307, US

(21) Appl. No.: 10/469,599

(22) PCT Filed: Mar. 1, 2002
(86) PCT No.: PCT/EP02/02226

(30) Foreign Application Priority Data
Mar. 2, 2001 (EP) 01105086.1

(51) Int. Cl. C08L 29/04

(52) U.S. Cl. 524/503

(57) ABSTRACT

The invention relates to a novel polypropylene compound based on halogen-free, flame-resistant filling materials containing magnesium hydroxide, said compound having good extrudability and improved flame protective action.

The subject of the invention is a filled propylene polymer compound with improved flameproof finish based on magnesium hydroxide.

To improve the mechanical and visual properties, propylene polymers are e.g. processed according to U.S. Pat. No. 4,847,317 or U.S. Pat. No. 4,990,554 with inorganic fillers to produce compounds. The compounds are characterized vis-à-vis unfilled propylene polymers by an increased impact resistance and mechanical hardness.

If the compound is also to display improved flame-protection properties in addition to improved mechanical material properties, flame-retardant, self-extinguishing-promoting and/or encrusting fillers, such as e.g. metal hydroxides, halogen-containing mostly brominated flameproofing agents or phosphorus-containing flameproofing agents such as e.g. ammonium polyphosphate, are incorporated.

Recently, magnesium hydroxides have proved to be advantageous halogen-free fillers for equipping polymers with a good flame-protection properties and flue-gas suppression properties. Typical fill levels are between 30 and 80 wt.-% relative to the overall quantity of compound.

Tests of the flame-protection properties of polymers are carried out e.g. in accordance with the Underwriters' Laboratories Safety Standards 94 and lead, if the test is passed, to a classification of the polymers or the compounds in fire-protection classes UL94 V2 to UL94 V0. A further common method for the evaluation of flame resistance is the measurement of the oxygen index (LOI) in accordance with ASTM D 2863. In this case, the oxygen concentration in a nitrogen/oxygen mixture is indicated at which a standardized testpiece just about continues to burn. A higher oxygen index correspondingly represents an improvement of the flameproofing effect.

For injection-moulded articles such as e.g. electrical parts or extrudates such as e.g. pipes, the highest classification in accordance with UL94 V0 is often required. However, with the current propylene polymer types with magnesium hydroxide, this can only be achieved as a rule with fill levels above 65 wt.-% relative to the compound (Table 1).

Even when using magnesium hydroxides of high surface, such as e.g. MAGNIFIN® H 10 or the coated type MAGNIFIN® H 10 F, with the most current propylene polymer types, as a rule only a classification in accordance with UL94 V1 can be achieved.

In order to achieve a classification in the flame resistance class UL 94 V0 in a propylene polymer compound, the compound would have to be filled to an even higher level with magnesium hydroxide. The same applies for the achievement of higher LOI values, Often, such as e.g. in cable sheaths, an LOI value clearly above 30% O₂ is required to satisfy current fire-protection standards in the finished cable. With fill levels above 65 wt.-% however, both the mechanical load-bearing capacity of the end-products and the rheological properties of the compound worsen during the processing, as a result of which the application range of high-filled flame-proofed propylene polymer compounds is limited.

To improve the adhesion between polymer and filler and thus the rheological and mechanical properties of the compound, maleic acid derivatives are incorporated e.g. according to U.S. Pat. No. 5,104,925 or the fillers coated with compatibility-promoting auxiliaries according to EP-0 292 233-A1. Fillers coated in this way are e.g. MAGNIFIN® H 5 GV or MAGNIFIN® H 5 KV from Martinswerk GmbH, Bergheim.

The object of the invention was the development of a propylene polymer compound through the addition of suitable additives, which with a flameproof finish based on magnesium-hydroxide-containing fillers as far as possible achieves the classification in accordance with UL94 V0 and/or LOI values above 30% O₂ and yet still has a sufficiently high flowability for extrusion and injection-moulding applications.

Contrary to the expectation that propylene polymers with magnesium hydroxide as flame-retardant filler can achieve a classification in accordance with UL94 V0 only with fill levels above 65%, the object according to the invention was able to be achieved by compounding of propylene polymers with coated magnesium hydroxide filler and ethylene/vinyl acetate copolymer according to claim 1.

The combination of filler coating and vinyl acetate has a synergistic effect. In addition to the desired flame retardance, the new compound can be processed e.g. by extrusion, and thus opens up new fields of application for flameproofed polymers.

The compound according to the invention contains propylene polymers in a quantity of 70 to 99 wt.-% relative to the overall polymer content.

Suitable propylene polymer types are for example isotactic propylene polymers of high or low crystallinity. Typical degrees of crystallinity are between 50 and 70%.

Suitable in particular are homopolymers of various molar mass and molar mass distribution and also block and random copolymers and elastomer blends obtainable by modification of the polymer composition. These include for example copolymers obtainable by modification with low α-olefins such as ethylene and butylene and also blends of propylene polymers with elastomers such as e.g. with ethylene/propylene/diene terpolymers (PP/EPDM blends).

The polymer is preferably a propylene polymer/α-olefin copolymer in the form of a block copolymer and/or a random copolymer and/or a polymer blend of a propylene polymer with at least one elastomer and/or at least one α-olefin polymer.

Also suitable are e.g. ethylene/styrene or ethylene/cycloolefin copolymers. The propylene polymer blends can also be produced in one work step during the compounding by addition of the corresponding polymers to the propylene polymers.

In a preferred version, the compound according to the invention contains propylene polymer in a quantity of 80 to 95 wt.-% relative to the overall polymer content.

The compound according to the invention contains ethylene/vinyl acetate copolymer in a quantity of 1 to 30 wt.-% relative to the overall polymer content.

The named ethylene/vinyl acetate copolymer has a vinyl acetate content of 6 to 80 wt.-%. In a further preferred version, the named ethylene/vinyl acetate copolymer has a vinyl acetate content of 12 to 80 wt.-%.

In a further preferred version, the compound according to the invention contains ethylene/vinyl acetate copolymer in a quantity of 5 to 20 wt.-% relative to the overall polymer content.

The compound contains as filler synthetic or natural magnesium hydroxide in a quantity of 25 to 80 wt.-% relative to the overall quantity of the compound.

In a preferred version, the named filler is contained in a quantity of 50 to 70 wt.-% relative to the overall quantity of the compound.

In a preferred version, the named filler is coated. The surface treatment of the filler is carried out in a preferred version with a derivative from the group of the polymer fatty acids, the keto fatty acids, the fatty alkyl oxazolines or bisoxazolines and optionally with a siloxane derivative or in another preferred version with a fatty acid and a siloxane derivative, both surface treatments also optionally being able to be combined.

By polymer fatty acids is meant compounds produced by oligomerization such as e.g. by di- or trimerization of corresponding fatty acids. Suitable representatives are e.g. polystearic acid, polylauric acid or polydecanoic acid (Henkel Referate 28, 1992, p. 39 ff).

By keto fatty acids are meant keto-group-containing fatty acids with preferably 10 to 30 C atoms. A preferred representative of a keto fatty acid is ketostearic acid (Henkel Referate 28, 1992, p. 34 ff).

By fatty alkyl oxazolines are meant oxazolines alkyl- or hydroxyalkyl-substituted in 2-position. The alkyl group preferably has 7 to 21 C atoms. Bisoxazolines are compounds which are synthesized from the hydroxyalkyloxazolines by reaction with diisocyanates. A preferred representative is e.g. 2-undecyl-oxazoline (Henkel Referate 28, 1992, p. 43 ff).

In the following explanations, quantities are given in parts parts per weight.

By a fatty acid is meant either a saturated or unsaturated fatty acid with preferably 10 to 30 C atoms, a mono- or polyunsaturated hydroxy fatty acid with preferably 10 to 30 C atoms such as e.g. hydroxynervonic acid or ricinoleic acid or a saturated hydroxy fatty acid such as e.g. hydroxystearic acid, or a derivative of the above compounds. Suitable natural fatty acids are e.g. stearic acid, lauric acid, myristic acid, palmitic acid, oleic acid or linoleic acid. Fatty acid salts or modified fatty acids such as e.g. stearic acid glycidyl methacrylate can be used as fatty acid derivatives. Saturated fatty acids or hydroxy fatty acids or derivatives thereof are preferably used.

To achieve the required property profile, the siloxane compound is absolutely necessary if fatty acids alone are used.

The named fatty acids or fatty acid derivatives can be used either individually or in combination in a quantity of 0.01 to 10 parts, preferably 0.05 to 5 parts per 100 parts filler.

The added quantity of the siloxane component is 0.01 to 20 parts, preferably 0.05 to 10 parts per 100 parts filler.

Suitable siloxane derivatives are oligoalkyl siloxanes, polydialkyl siloxanes such as e.g. polydimethyl siloxane, polydiethyl siloxane, polyalkylaryl siloxanes such as e.g. polyphenylmethyl siloxane or polydiaryl siloxanes such as e.g. polyphenyl siloxane.

The named siloxanes can be functionalized with reactive groups such as e.g. hydroxy, amino, vinyl, acryl, methacryl, carboxyl or glycidyl groups.

High-molecular polydialkyl siloxanes, so-called silicone oils, which have optionally been functionalized with the named groups, are preferably used as siloxane derivatives.

The magnesium hydroxide can be coated for example according to WO 96/26240 with fatty acids and silicone oil.

The compounds produced according to the invention are characterized by a higher flame resistance compared with corresponding propylene polymer compounds without ethylene/vinyl acetate copolymer admixtures.

The compounds according to the invention achieve a limiting oxygen index of at least 25%, preferably at least 30% (specimen dimensions 6×3×150 mm³). In the examples given, values in a range from 31 to 36% at a fill level of 65% relative to the overall quantity of the compound were determined.

The filled compounds obtained according to claim 1 can additionally contain additives to improve elongation at break, such as e.g. maleic anhydride.

The filled compounds obtained according to claim 1 can additionally contain fibrous additives for reinforcement. Fibrous additives include for example glass fibres, stone fibres, metal fibres, ceramic fibres, including the monocrystals, the so-called “whiskers” and likewise all fibres stemming from synthetic polymers such as aramide, carbon, polyamide, polyacrylic and polyester fibres.

In addition to the named additives, the compounds according to the invention can contain further application-related additives or auxiliaries such as e.g. calcium carbonate, polyethylene waxes and/or stabilizers and/or antioxidants.

The compounds can also be coloured with suitable pigments and/or dyes.

The named additives and colorants can be contained individually or in combination.

Although the present invention is fully disclosed by the listed Examples 1 to 7 according to the invention, numerous further examples according to the invention can also be formulated, due to the claimed variations of the educts. These examples, which are achieved by modifications of the composition within the variations defined in the description and in the claims, are considered to be examples according to the invention and come within the scope of protection of this patent application.

### EXAMPLES

All the testpieces were produced from the compounds by means of injection moulding. The behaviour in fire was tested in accordance with UL 94 V using testpieces with a material thickness of 3.2 mm. The LOI rods display specimen dimensions of 6×3×150 mm³ in accordance with ASTM D 2863.

Force loads of 5 kg at 230° C. were used for the melt flow index measurements. The results of the studies of rheological and mechanical properties, and of the behaviour in fire of the compounds from the comparison examples V1 to V5 are reproduced in Table 1.

The results of the studies of rheological and mechanical properties, and of the behaviour in fire of the compounds from comparison example V5 and the examples 1 to 7 according to the invention are reproduced in Table 2. In the case of examples 1 to 7 the synergistic effect of the vinyl acetate on the flame behaviour of the propylene polymer compounds is seen.

### Example V1

### Comparison

350 g of partly-crystalline Novolen® 3200 H propylene polymer (BASF/BASELL, 35 wt.-% relative to the compound) were compounded on a type W150M Collin's roll mill with 650 g of MAGNIFIN® H 5 magnesium hydroxide filler (65 wt.-% relative to the compound) at a roll temperature of 170° C. The compounding time was 35 min.

### Example V2

### Comparison

350 g of partly crystalline Novolen® 3200 H propylene polymer (BASF/BASELL, 35 wt.-% relative to the compound) were compounded on a type W150M Collin's roll mill with 650 g of MAGNIFIN® H 5 GV magnesium hydroxide filler (65 wt.-% relative to the compound) at a roll temperature of 170° C. The compounding time was 35 min.

### Example V3

### Comparison

350 g of partly crystalline Novolen® 3200 H propylene polymer (BASF/BASELL, 35 wt.-% relative to the compound) were compounded on a type W150M Collin's roll mill with 650 g of MAGNIFIN® H 5 HV magnesium hydroxide filler (65 wt.-% relative to the compound) at a roll temperature of 170° C. The compounding time was 35 min.

### Example V4

### Comparison

350g of partly crystalline Novolen® 3200 H propylene polymer (BASF/BASELL, 35 wt.-% relative to the compound) were compounded on a type W150M Collin's roll mill with 650 g of MAGNIFIN® H 5 KV magnesium hydroxide filler (65 wt.-% relative to the compound) at a roll temperature of 170° C. The compounding time was 35 min.

### Example V5

### Comparison

350g of partly crystalline Novolen® 3200 H propylene polymer (BASF/BASELL, 35 wt.-% relative to the compound) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

### Example 1

340 g of partly crystalline Novolen® 3200 H propylene polymer (BASF/BASELL, 34 wt.-% relative to the compound; 97.1 wt.-% relative to the overall polymer) and 10 g of Escorene® Ultra UL40028 (ethylene/vinyl acetate copolymer (EVA)), 28 wt.-% VA copolymer, Exxon, 1% relative to the compound; 2.9 wt.-% relative to the overall polymer) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

### Example 2

340 g of partly crystalline Novolene 3200 H propylene polymer (BASF/BASELL, 34 wt.-% relative to the compound; 97.1 wt.-% relative to the overall polymer) and 10 g of Escorene® Ultra UL00328 (EVA, 27wt.-% VA copolymer, Exxon, 1% relative to the compound; 2.9 wt.-% relative to the overall polymer) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

### Example 3

310 g of partly crystalline Novolen® 3200 H propylene polymer (BASF/BASELL, 31 wt.-% relative to the compound; 88.6 wt.-% relative to the overall polymer) and 40 g of Escorene® Ultra UL00328 (EVA, 27 wt.-% VA copolymer, Exxon, 4% relative to the compound; 11.4 wt.-% relative to the overall polymer) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

### Example 4

290 g of partly crystalline Novolen® 3200 H propylene polymer (BASF/BASELL, 29 wt.-% relative to the compound; 82.9 wt.-% relative to the overall polymer) and 60 g of Escorenee Ultra UL00328 (EVA, 27 wt.-% VA copolymer, Exxon, 6% relative to the compound; 17.1 wt.-% relative to the overall polymer) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

### Example 5

340 g of partly crystalline Novolen® 3200 H propylene polymer (BASF/BASELL, 34 wt.-% relative to the compound; 97.1 wt.-% relative to the overall polymer) and 10 g of Levapren® 700 (EVA, 70 wt.-% VA copolymer, Bayer, 1% relative to the compound; 2.9 wt.-% relative to the overall polymer) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

### Example 6

310 g of partly crystalline Novolen® 3200 H propylene polymer (BASF/BASELL, 31 wt.-% relative to the compound; 88.6 wt.-% relative to the overall polymer) and 40 g of Levaprene 700 (EVA, 70 wt.-% VA copolymer, Bayer, 4% relative to the compound; 11.4 wt.-% relative to the overall polymer) were compounded on a type W150M Collin's roll mill with 6509 of MAGNIFIN® H 5 MV magnesium hydroxide filler (65 wt.-% relative to the compound) at a roll temperature of 170° C. The compounding time was 35 min.

### Example 7

290 g of partly crystalline Novolen® 3200 H propylene polymer (BASF/BASELL, 29 wt.-% relative to the compound; 82.9 wt.-% relative to the overall polymer) and 60 g of Levapren® 700 (ethylene/vinyl acetate copolymer (EVA), 70 wt.-% VA copolymer, Bayer, 6% relative to the compound; 17.1 wt.-% relative to the overall polymer) were compounded on a type W150M Collin's roll mill with 650 g of MAGNIFIN® H 5 MV magnesium hydroxide filler (65 wt.-% relative to the compound) at a roll temperature of 170° C. The compounding time was 35 min.

Explanatory notes relating to Tables 1 and 2, and to the measurement methods:

| | |
|---|---|
| Melt flow index (MFI) | in accordance with DIN 53 735 |
| n.m. | not measured |
| Tensile strength/elongation at break | in accordance with DIN 53 455 |
| on injected testpieces for propylene | |
| polymer compounds | |
| Elastic modulus | in accordance with DIN 53 457 |
| Impact strength (Charpy) | in accordance with DIN 53 453 |
| n.b. | no break |
| Fire-protection behavior | in accordance with UL 94 V |
| n.a. | UL classification not achieved |
| LOI (limiting oxygen index) | in accordance with ASTM D 2863 |

TABLE 1

| | Example | | | | |
|---|---|---|---|---|---|
| | V1 | V2 | V3 | V4 | V5 |
| Filler | H 5 | H 5 GV | H 5 HV | H 5 KV | H 5 MV |
| MFI [g/10 min] | n.m. | 9.4 | 9.6 | 8.1 | 10.0 |
| Tensile strength | 19.2 | 12.5 | 12.4 | 12.2 | 13.9 |
| [MPa] | | | | | |
| Elongation at | 0.9 | 173 | 103 | 166 | 202 |
| break [%] | | | | | |
| Elastic modulus | 3069 | 2051 | 2023 | 1931 | 2746 |
| [MPa] | | | | | |
| Impact resistance | 8.2 | n.b. | n.b. | n.b. | n.b. |
| [kJ/m²] | | | | | |
| UL94 | n.a. | n.a. | n.a. | n.a. | V2 |
| LOI [% O₂] | 28.2 | 28.8 | 29.0 | 28.2 | 30.4 |

TABLE 2

| | Example | | | | | | | |
|---|---|---|---|---|---|---|---|---|
| | V5 | 1 | 2 | 3 | 4 | 5 | 6 | 7 |
| Novolen | 35 | 34 | 34 | 31 | 29 | 34 | 31 | 29 |
| [wt.-%] | | | | | | | | |
| UL40028 | — | 1 | — | — | — | — | — | — |
| [wt.-%] | | | | | | | | |
| UL00328 | — | — | 1 | 4 | 6 | — | — | — |
| [wt.-%] | | | | | | | | |
| Levapren 700 | — | — | — | — | — | 1 | 4 | 6 |
| [wt.-%] | | | | | | | | |
| H 5 MV | 65 | 65 | 65 | 65 | 65 | 65 | 65 | 65 |
| [wt.-%] | | | | | | | | |
| MFI | 10 | 7.5 | 6.2 | 6.5 | 6.0 | 9.1 | 7.7 | 7.0 |
| [g/10 min] | | | | | | | | |
| Tensile strength | 13.9 | 13.8 | 13.8 | 13.8 | 13.5 | 13.7 | 12.4 | 11.6 |
| [MPa] | | | | | | | | |
| Elongation at | 202 | 124 | 179 | 93 | 53 | 225 | 144 | 79 |
| break [%] | | | | | | | | |
| Elastic modulus | 2746 | 2651 | 2688 | 2487 | 2267 | 2741 | 2394 | 2191 |
| [MPa] | | | | | | | | |
| Impact | n.b. | n.b. | n.b. | n.b. | n.b. | n.b. | n.b. | n.b. |
| resistance | | | | | | | | |
| [kJ/m²] | | | | | | | | |
| UL94 | V2 | V1 | V1 | V0 | V0 | V1 | V0 | V0 |
| LOI | 30.4 | 31.8 | 32.2 | 32.2 | 33.0 | 32.4 | 35.0 | 36.0 |
| [% O₂] | | | | | | | | |

1. Flame-retardant polymer compound containing at least
a) a propylene polymer in a quantity of 70 to 99 wt.-% relative to the overall polymer content,
b) an ethylene/vinyl acetate copolymer in a quantity of 1 to 30 wt.-% relative to the overall polymer content, with a vinyl acetate content of 6 to 80 wt.-%,
c) a halogen-free flame-retardant filler based on natural or synthetic magnesium hydroxide in a quantity of 25 to 80 wt.-% relative to the overall quantity of the compound, the filler used being surface treated with
i) one or more of the fatty acid derivatives from the group of polymer fatty acids, keto fatty acids or fatty alkyloxazolines or bisoxazolines and optionally a siloxane derivative and/or
ii) a fatty acid and a siloxane derivative.

2. Flame-retardant polymer compound according to claim 1, characterized in that it contains propylene polymer in a quantity of 80 to 95 wt.-% relative to the polymer content.

3. Flame-retardant polymer compound according to one of claims 1 to 2, characterized in that the propylene polymer is
a) a propylene/α-olefin copolymer in the form of a block copolymer and/or a random copolymer and/or
b) a polymer blend of a propylene polymer with at least one further elastomer and/or at least one α-olefin copolymer.

4. Flame-retardant polymer compound according to one of claims 1 to 3, characterized in that the ethylene/vinyl acetate copolymer has a vinyl acetate content of 12 to 80 wt.-%.

5. Flame-retardant polymer compound according to one of claims 1 to 4, characterized in that it contains an ethylene/vinyl acetate copolymer in a quantity of 5 to 20 wt.-% relative to the polymer content.

6. Flame-retardant polymer compound according to one of claims 1 to 5, characterized in that the flame-retardant filler is contained in a quantity of 25 to 80 wt.-% relative to the compound.

7. Flame-retardant polymer compound according to one of claims 1 to 5, characterized in that the flame-retardant filler is contained in a quantity of 50 to 70 wt.-% relative to the compound.
